(19) United States
(12) Patent Application Publication
(10) Pub. No.: US 2006/0118652 A1
(43) Pub. Date: Jun. 8, 2006

(54) Push/tow broadcast spreader

(76) Inventors: Ronald J. Hickenbottom, Sullivan, IL (US); Jay Taber, Sullivan, IL (US)

Correspondence Address: MICHAEL J. TURGEON;VEDDER PRICE KAUFMAN & KAMMHOLZ, 222 N. LASALLE STREET, CHICAGO, IL, 60601, US

(21) Appl. No.: 11/005,382

(22) Filed: Dec. 6, 2004

(51) Int. Cl. A01G 25/09; B05B 9/00

(52) U.S. Cl. 239/146; 239/147; 239/149

(57) ABSTRACT

A broadcast spreader including a frame for supporting a hopper and connection with a ground engaging assembly. A pair of brackets are connected to each of the sides of the frame. A pair of legs and a pair of arms each engage one of the brackets such that the legs and arms are convertibly oriented in a push configuration and a tow configuration.

The present disclosure is directed to broadcast spreaders, and more particularly, to a broadcast spreader which may be used in a push configuration and converted for use in a tow configuration.

Presently available material spreaders are used for spreading material such as grass seed, fertilizer, sand or ice melters, for example, over the ground in a controlled spread pattern. The material spreaders also control the flow rate of the material.

There are presently available material spreaders that are capable of being pulled and pushed. However, such spreader do not include all of the parts necessary to convert from a push configuration to a pull configuration and then back again. Presently available material spreaders require that certain parts used in one configuration be removed and replaced with different parts for use in the other configuration. The parts which are not used in the one or the other configurations must be stored in a separate location. A major disadvantage of such presently available material is that the parts which are in storage are often lost and increases the time and complexity of the conversion.

Therefore, there exists a need in the art for a broadcast spreader which can be converted from a push configuration to a tow configuration using only the parts connected to the broadcast spreader that can also be manipulated without tools. Such a broadcast spreader is advantages in that the conversion can be accomplished quickly and without tools. Further advantageous include a broadcast spreader that is inexpensive, easy to convert and does not require tools for any disassembly or assembly thereof.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 illustrates a perspective view of a broadcast spreader in a push configuration;

FIG. 2 illustrates a side elevation view of the broadcast spreader of FIG. 1;

FIG. 3 illustrates a partially exploded view of the broadcast spreader of FIG. 1;

FIG. 4 illustrates a partially exploded view of the broadcast spreader of FIG. 1 converted from the push configuration to a tow configuration;

FIG. 5 illustrates a side elevation view of the broadcast spreader of FIG. 4; and

FIG. 6 illustrates a perspective view of the broadcast spreader of FIG. 4.

### DETAILED DESCRIPTION

For the purposes of promoting and understanding the principles disclosed herein, reference will now be made to the preferred embodiments illustrated in the drawings and specific language will be used to describe the same. It will nevertheless be understood that no limitation of the scope is thereby intended. Such alterations and further modifications in the illustrated device and such further applications are the principles disclosed as illustrated therein as being contemplated as would normally occur to one skilled in the art to which this disclosure relates.

In accordance with one principle aspect to the present disclosure, a broadcast spreader includes a frame for supporting a hopper and connection with a ground engaging assembly. A pair of brackets are connected to each of the sides of the frame. A pair of legs and a pair of arms each engage one of the brackets such that the legs and arms are convertibly oriented in a push configuration and a tow configuration.

In accordance with another aspect of the present disclosure, a broadcast spreader includes a frame for supporting a hopper and connection with a ground engaging assembly. A pair of brackets each including a first end and a second end and one bracket is connected to each of the first and second sides of the frame. A pair of arms are removably connected to the first end of one of the brackets to define a push configuration and each arm may be disconnected from the respective first end of one of the brackets and each arm may be removably connected to the second end of one of the brackets to define a tow configuration.

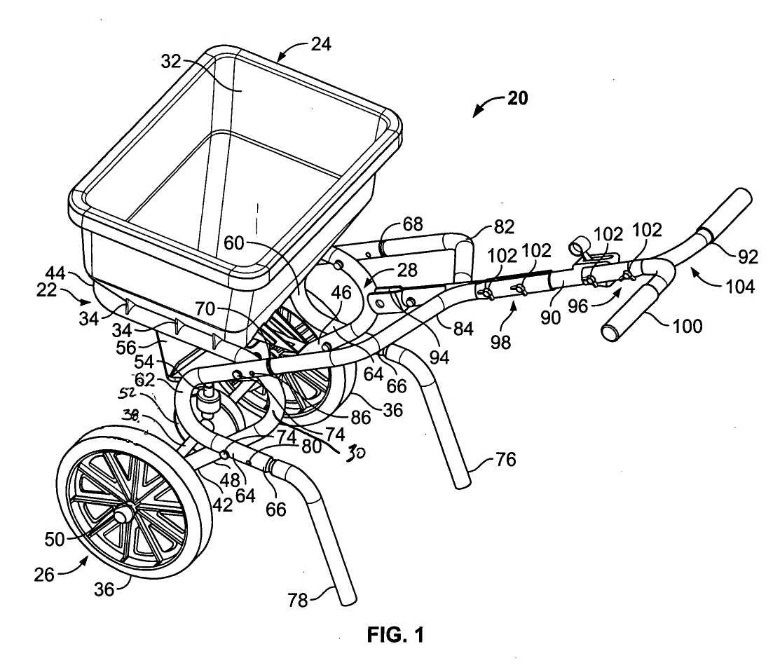

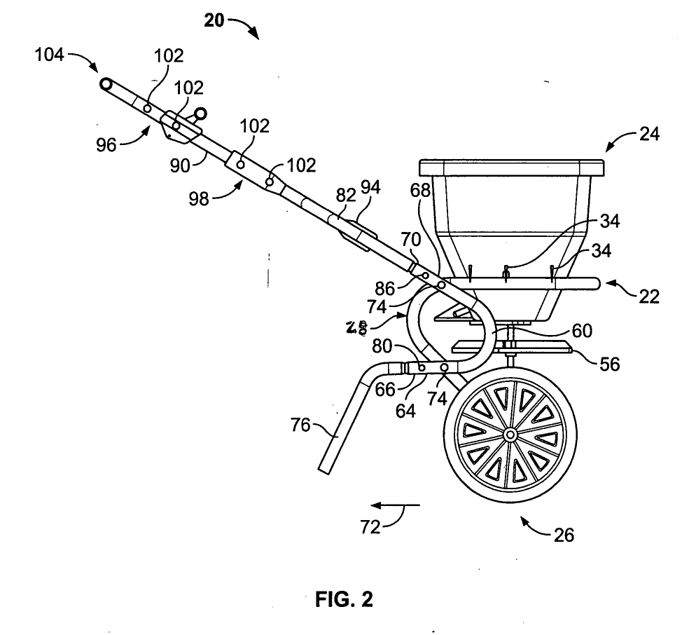

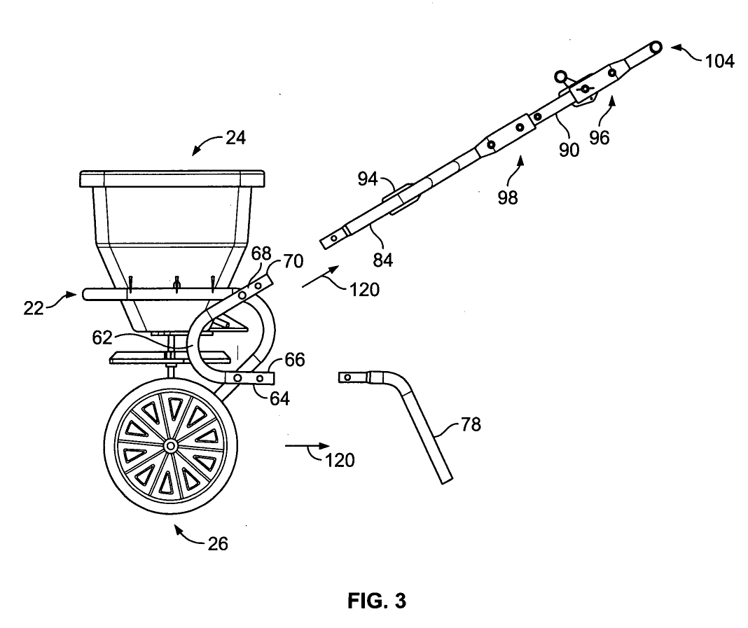

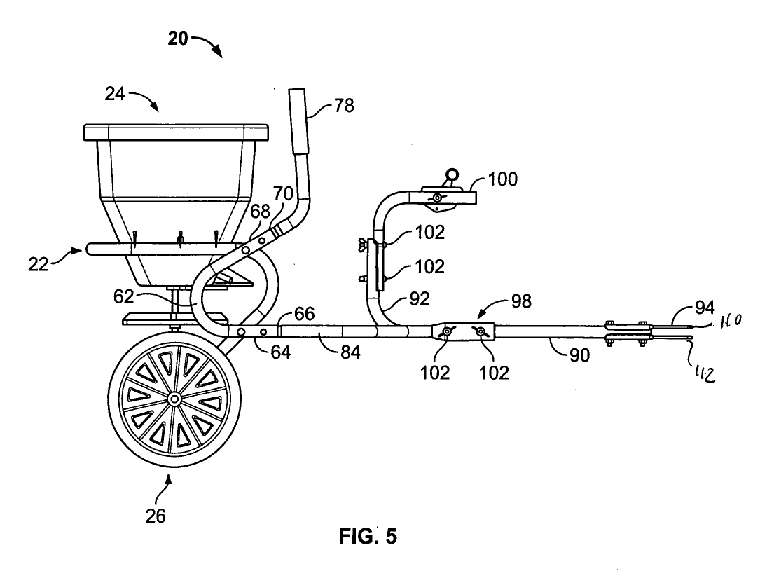

FIG. 1 illustrates a perspective view, FIG. 2 illustrates a side elevation view and FIG. 3 illustrates a partially exploded view, all of a broadcast spreader 20 in a push configuration. The broadcast spreader 20 is useful for spreading material such as grass seed, fertilizer, sand and ice melters, for example, on the ground in various desired spread patterns at various selected flow rates. The broadcast spreader 20 generally includes a frame 22 for supporting a hopper 24 and for connection with a ground engaging assembly 26. The frame 22 includes opposing first and second sides 28, 30. The frame 22 may be formed as a hollow tube bent into the shape shown in FIGS. 1-6 so as to have a substantially horizontal upper portion 44 and downwardly extending lower portions 46, 48. Lower ends 40, 42 are formed at the distal end of the lower portions 46, 48.

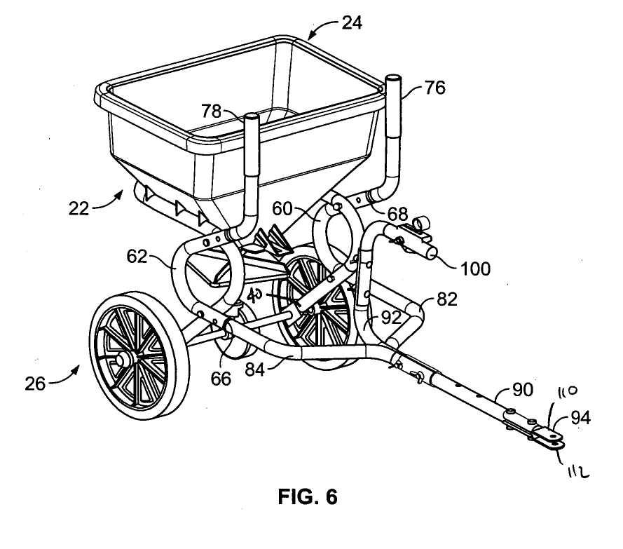

The hopper 24 has an open top 32, which is generally rectangular as may be seen in FIGS. 1 and 6, to enable supply to the hopper 24 of the material to be spread. It is within the teachings of the present invention that the hopper and open top may also have any other suitable shape. For example, the hopper and open top may have a circular, conical, pyramidal, generally inverted frusto-pyramidal or any other suitable configuration. In this embodiment, the hopper 24 includes a plurality of limbs 34 which engage the frame 22 to maintain the hopper 24 in spaced relation to the ground engaging assembly 26. Threaded fasteners may be used to secure the hopper 24 to the frame 22. It is within the teachings of the present disclosure that any other suitable structure, device or method may be used to facilitate connection of the hopper 24 to the frame 22. For example, adhesives, hook and loop fasteners, welding, or any other suitable method or device may be used to connect the hopper 24 to the frame 22. However, it is also within the teachings of the present disclosure that the hopper 24 is not required to be connected to the frame 22.

The first and second sides 28, 30 of the frame 22 engage the ground engaging assembly 26 at spaced lower ends 40, 42. In particular, the ground engaging assembly 26 includes a pair of wheel and tire assemblies 36 disposed at opposing ends of an axle 38 for rolling along the ground. The lower ends 40, 42 of respective first and second sides 28, 30 engage the axle 38 adjacent each wheel and tire assembly 36 to facilitate relative movement of the axle 38 with respect to the frame 22.

Each of the wheel and tire assemblies 36 is the same and has a hub 50 for mounting on an end of the axle 38. Preferably, each of the hubs 50 include structure, device or a method for indexing or connecting the wheel and tire assembly 36 to the axle 38 so that the axle 38 rotates in response to rotation of the wheel and tire assembly 36.

A transmission 52 engages the axle 38 and converts rotation of the axle to rotation of a drive shaft 54, which in turn rotates the spreader plate 56 connected thereto. It is within the teachings of the present invention that any conventional transmission may be used which converts rotation along one axis to rotation along another axis.

As may be seen in FIGS. 1-3, the broadcast spreader 20 further includes a pair of brackets 60, 62. One of the brackets 60, 62 is connected to one of the respective first and second sides 28, 30. As may be seen in FIGS. 1-6, for consistency herein bracket 60 is connected to first side 28 and bracket 62 is connected to second side 30. Preferably, each bracket 60, 62 is generally V-shaped and connected to the respective first or second side 28, 30 such that a second leg 64 is disposed substantially horizontal and has a second end 66 at a distal end thereof. The first leg 68 of each bracket 60, 62 is preferably oriented oblique with respect to the second leg 64 and has a first end 70 disposed at a distal end thereof, such that the first and second legs 64, 68 extend generally in a same direction indicated by arrow 72.

In one embodiment, each bracket 60, 62 is connected to the respective first and second side 28, 30 by threaded fasteners 74. It is within the teachings of the present disclosure, that any other suitable structure, method or device may be used to connect the bracket 60, 62 to the respective first and second sides 28, 30. For example, locking pins, welding, or any other suitable structure, device or manner.

A pair of legs 76, 78 engage, in one embodiment, the second end 66 of the respective brackets 60, 62. Such engagement may be characterized by a slip fit connection, wherein the leg 76, 78 is configured to have an outer diameter that is less than the inner diameter of the second end 66, such that the leg 78 is received within the second end 66. Preferably, a mechanical device may be used to securely connect the legs 76, 78 to the respective brackets 60, 62. For example, a snap button 80 disposed on the legs 76, 78 may be configured to engage an aperture formed adjacent the second end 66 of each respective bracket 60, 62 to provide a removable connection of the legs 76, 78 to the respective brackets 60, 62. It is within the teachings of the present disclosure that other removable connections may be formed on the legs 76, 78 or brackets 60, 62 to facilitate such removable connection of the legs 76, 78 thereto, including, but not limited to a reversal of parts disclosed herein or any other suitable connection device or apparatus.

A pair of arms 82, 84 are configured to engage the first end 70 of respective brackets 60, 62. It is within the teachings of the present disclosure that each arm 82, 84 may have an end configured to have an outer diameter less than the inner diameter of the second end 70 of the respective bracket 60, 62 such that the arms 82, 84 may engage the first ends 70 of the respective bracket 60, 62 in a slip fit manner. Preferably, a mechanical connection device or apparatus is connected to the arms 82, 84 or second ends 70 of the respective brackets 60, 62 to facilitate a removable connection therebetween. For example, a snap button 86 may be provided as described in detail above. It is within the teachings of the present disclosure that any other suitable device which facilitates a removable connection between the arms 82, 84 and the respective brackets 60, 62 may be used.

In one embodiment, the broadcast spreader 20 further includes an interface link 90 having a first end 92 configured as a first handle portion and a second end 94 configured in one embodiment as clevis for connection to a land vehicle (not shown), a first attachment region 96 adjacent the first end 92 and a second attachment region 98 adjacent the second end 94.

The broadcast spreader 20 may further include a second handle portion 100 connected to the interface link 90 in the first attachment region 96 with removable fasteners 102 that do not require tools, such that the first and second handle portions 92, 100 cooperatively define a handle 104.

The interface link 90 is connected to the arms 82, 84 in the first attachment region 98 by at least one removable fastener 102 that does not require tools to manipulate. A suitable removable fastener 102 may include a threaded fastener and a wing nut, a lock pin, a pin with a cotter pin, opposing snap buttons, or any other suitable connection device, structure or manner that provides a suitable removable connection. Likewise, when the second handle portion 100 is connected to the interface link 90 in the first attachment region 96, at least one removable fastener 102 that does not require a tool to manipulate, is preferably used. It is within the teachings of the present invention that similar removable fasteners may be used as described in detail above to provide the removable connection.

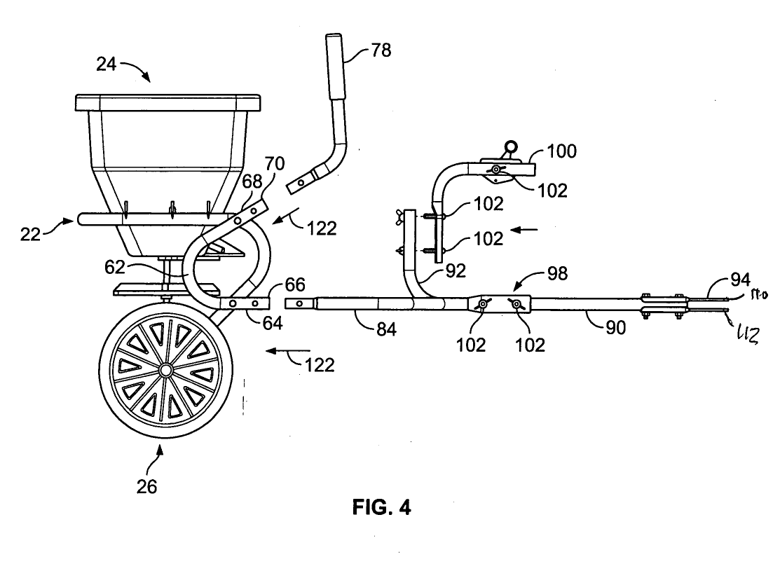

As shown in FIG. 3, the legs 76, 78 and arms 82, 84 may be disconnected from the respective brackets 60, 62 and moved in the direction of arrows 120 to facilitate conversion from a push configuration, as may be seen in FIGS. 1-3, to a tow configuration, as may be seen in FIGS. 4-6.

The push configuration is defined when each of the arms 82, 84 is removably connected to a first end 70 of one of the brackets 60, 62 and each of the legs 76, 78 is removably connected to a second end 66 of one of the brackets 60, 62.

The tow configuration is defined when each of the legs 76, 78 is removably connected to a first end 70 of one of the brackets 60, 62 and each of the arms 82, 84 is removably connected to a second end 66 of one of the brackets 60, 62.

As may be seen in FIGS. 4-6, the pair of arms 82, 84 and the pair of legs 76, 78 have been convertibly oriented from the push configuration to the tow configuration when moved in the direction of arrows 122. Each of the legs 76, 78, in one embodiment of the tow configuration, is oriented for removable connection with the first end 70 of the respective brackets 60, 62 and each of the arms 82, 84 is oriented for removable connection with the second end 66 of the respective bracket 60, 62.

In the tow configuration, the interface link 90 has been longitudinally rotated 180 degrees and axially rotated 90 degrees from the orientation thereof in the push configuration, such that the arms 82, 84 are connected thereto in the first attachment region 98 adjacent the second end 90 by at least one removable fastener 102 that does not require tools. Preferably, the removable fastener 102 used in this embodiment of the broadcast spreader 20 of the present disclosure is the same as described above or a suitable equivalent thereof. As a result of such orientation, the second end 94, in the tow configuration, is disposed in a location remote from the arms 82, 84. It is within the teachings of the present disclosure that the second end 94 may be configured as a clevis for connection to a land vehicle (not shown). In one embodiment, the clevis may be defined by upper and lower flanges 110, 112 connected to opposing sides of the interface link 90. It will be recognized by those of skill in the art that any other suitable structure may be defined at the second end 94 of the interface link 90 to facilitate connection with a land vehicle (not shown).

The second handle portion 100, in the tow configuration, is connected to the first handle portion 92 in a third attachment region 114 with a plurality of removable fasteners 102 that do not require tools. It will be recognized by those of skill in the art that the removable fasteners 102 are the same as set forth in detail above, or suitable equivalents thereof, such that all of the structure necessary to convert the broadcast spreader 20 from a push configuration to a tow configuration and then back again is presently disposed on the broadcast spreader and no tools are required to convert from the push configuration to the tow configuration.

In operation, the broadcast spreader 20 disposed in the push configuration may be converted to the tow configuration without tools. First, the fasteners 102 are manipulated by hand to disconnect the second handle portion 100 from the first attachment region 96 of the interface link 90. Next, the second handle portion 100 is removably connected, without tools, to the first handle portion 92 using the same fasteners 102 from the previous step. Next, the fasteners 102 in the second attachment region 98 are manipulated by hand to disconnect the interface link 90 from the arms 82, 84. Next, the interface link 90 is rotated longitudinally 180 degrees and axially 90 degrees and removably connected to the arms 82, 84 with the same fasteners 102 from the previous step in the first attachment region 96. Next, the arms 82, 84 are disconnected from the first end 70 of each of the first and second brackets 60, 62. Next, the legs 76, 78 are disconnected from the second end 66 of each of the first and second brackets 60, 62. Next, the arms 82, 84 are removably connected to the first end 70 of each of the first and second brackets 60, 62. Finally, the legs 76, 78 are removably connected to the second end 66 of each of the first and second brackets 60, 62, such that the broadcast spreader 20 is oriented in the tow configuration. It will be recognized by those of skill in the art that to convertibly re-orient the broadcast spreader 20 from the tow configuration to the push configuration, the above-mentioned steps are generally reversed in order of performance.

Furthermore, while the particular preferred embodiments have been shown and described, it will be obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. A broadcast spreader comprising:
a frame for supporting a hopper and connection with a ground engaging assembly, the frame including opposing first and second sides;
a pair of brackets, wherein one bracket is connected to each of the first and second sides; and
a pair of legs and a pair of arms, wherein one of the legs and one of the arms engages each of the brackets such that the legs and arms are convertibly oriented in a push configuration and a tow configuration.

2. The broadcast spreader as recited in claim 1, wherein the push configuration is defined when each of the arms is removably connected to a first end of one of the brackets and each of the legs is removably connected to a second end of one of the brackets.

3. The broadcast spreader as recited in claim 1, wherein the tow configuration is defined when each of the legs is removably connected to a first end of one of the brackets and each of the arms is removably connected to a second end of one of the brackets.

4. The broadcast spreader as recited in claim 1, further including an interface link having a first end configured as a first handle portion, a second end configured as a clevis for connection to a land vehicle, a first attachment region adjacent the first end and a second attachment region adjacent the second end.

5. The broadcast spreader as recited in claim 4, wherein, when disposed in the push configuration, each of the arms is connected to the second attachment region with removable fasteners that do not require tools.

6. The broadcast spreader as recited in claim 5, wherein a second handle portion is connected to the first attachment region with removable fasteners that do not require tools, such that the first and second handle portions cooperatively define a handle.

7. The broadcast spreader as recited in claim 4, wherein, when disposed in the tow configuration, each of the arms is connected to the first attachment region with removable fasteners that do not require tools.

8. The broadcast spreader as recited in claim 7, wherein a second handle portion is connected to the first end.

9. The broadcast spreader as recited in claim 1, wherein no tool is required to convert from the push configuration to the tow configuration.

10. A broadcast spreader comprising:
a frame for supporting a hopper and connection with a ground engaging assembly, the frame including a first side and a second side;
a pair of brackets each including a first end and a second end, wherein one bracket is connected to each of the first and second sides; and
a pair of arms, wherein each arm is removably connected to the first end of one of the brackets to define a push configuration and each arm may be disconnected from the respective first end of one of the brackets and each arm may be removably connected to the second end of one of the brackets to define a tow configuration.

11. The broadcast spreader as recited in claim 10, further including a pair of legs, wherein each leg is removably connected to the second end of one of the brackets to define a push configuration and each leg may be disconnected from the respective second end of one of the brackets and each leg may be removably connected to the first end of one of the brackets to define tow configuration.

12. The broadcast spreader as recited in claim 10, wherein the push configuration is defined when each of the arms is removably connected to a first end of one of the brackets and each of the legs is removably connected to a second end of one of the brackets.

13. The broadcast spreader as recited in claim 10, wherein the tow configuration is defined when each of the legs is removably connected to a first end of one of the brackets and each of the arms is removably connected to a second end of one of the brackets.

14. The broadcast spreader as recited in claim 10, further including an interface link having a first end configured as a first handle portion, a second end configured as a clevis for connection to a land vehicle, a first attachment region adjacent the first end and a second attachment region adjacent the second end.

15. The broadcast spreader as recited in claim 14, wherein, when disposed in the push configuration, each of the arms is connected to the second attachment region with removable fasteners that do not require tools.

16. The broadcast spreader as recited in claim 15, wherein a second handle portion is connected to the first attachment region with removable fasteners that do not require tools, such that the first and second handle portions cooperatively define a handle.

17. The broadcast spreader as recited in claim 14, wherein, when disposed in the tow configuration, each of the arms is connected to the first attachment region with removable fasteners that do not require tools.

18. The broadcast spreader as recited in claim 17, wherein a second handle portion is connected to the first end.

19. The broadcast spreader as recited in claim 10, wherein no tool is required to convert from the push configuration to the tow configuration.
